(19) United States
(12) Patent Application Publication
(10) Pub. No.: US 2006/0212700 A1
(43) Pub. Date: Sep. 21, 2006

(54) Method for processing network selection information for a user terminal in a wireless local area network

(76) Inventor: Wenlin Zhang, Guangdong (CN)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/324,548

(22) Filed: Jan. 3, 2006

Related U.S. Application Data
(63) Continuation-in-part of application No. PCT/CN04/00739, filed on Jul. 2, 2004.

(30) Foreign Application Priority Data
Jul. 3, 2003 (CN) 03148222.8

(51) Int. Cl. H04L 9/00

(52) U.S. Cl. 713/167

(57) ABSTRACT

The present invention discloses a method for processing network selection information for a user terminal in wireless local area network (WLAN). When a WLAN user terminal accesses a wireless communications network via a WLAN access network (WLAN AN), the WLAN user terminal sends to the WLAN AN an authentication signal carrying network selection information. This network selection information of the user terminal may be placed in a user identity field defined in the format of a network access identifier (NAI). This invention enables the user terminal to select an appropriate wireless communication network to access when attempting to access a network via a WLAN connecting a plurality of wireless communication networks.

### CROSS-REFERENCE TO RELATED APPLICATIONS

This application is a continuation-in-part of PCT Application No. PCT/CN2004/000739, filed Jul. 2, 2004, pending, which designates the U.S., which is hereby incorporated herein by reference in its entirety, and which claims priority from Chinese Application No. 03148222.8, filed Jul. 3, 2003.

### FIELD OF THE INVENTION

The present invention relates to network accessing techniques, and more particularly to a method for processing network selection information for a user terminal in a wireless local area network (WLAN).

### BACKGROUND OF THE INVENTION

Users are demanding increasingly high rates of wireless access. WLAN can provide high-rate wireless data access in a relatively small area. The majority of WLANs use the technical standard IEEE 802.11b. This standard utilizes a 2.4 GHz frequency band with a data transmission rate up to 11 Mbps. Other technical standards utilizing the same frequency band include IEEE 802.11g and the Bluetooth, wherein the data transmission rate of IEEE 802.11g is up to 54 Mbps. Other standards include IEEE 802.11a and ETSI BRAN Hiperlan2, which use a 5 GHz frequency band with a transmission rate of up to 54 Mbps as well.

Although there are various standards for wireless access, most WLANs are used for transferring IP data packets. The specific WLAN access standard adopted by a wireless IP network is usually transparent to the upper-level IP. Such a network is typically configured with Access Points (AP) for implementing wireless access for a user terminal and with network controlling and connecting devices for implementing IP transmission.

With the rise and development of WLANs, research is focusing on the inter-workings of WLANs with various wireless mobile communications networks, such as GSM, CDMA, WCDMA, TD-SCDMA, and CDMA2000. In accordance with the 3GPP standards, a user terminal can connect with the Internet and Intranets, as well as home networks and visited networks of 3GPP systems via a WLAN access network (WLAN AN). As an example, for local access, a WLAN user terminal can connect to a 3GPP home network via the WLAN AN, as shown in FIG. 2. When roaming, the WLAN user terminal can connect to a 3GPP visited network via the WLAN AN. Some entities of the 3GPP visited network are connected to corresponding entities of the 3GPP home network. For example, the 3GPP Authentication Authorization Accounting (AAA) Proxy in the visited network can be connected to the 3GPP AAA server in the home network, and the WLAN Access Gateway (WAG) in the visited network can be connected to the Packet Data Gateway (PDG) in the home network, as shown in FIG. 1. FIG. 1 and FIG. 2 are schematic diagrams illustrating the networking architectures of a WLAN inter-working with a 3GPP system under roaming and non-roaming circumstances, respectively.

As shown in FIG. 1 and FIG. 2, a 3GPP system primarily includes a Home Subscriber Server (HSS)/ Home Location Register (HLR), a 3GPP AAA server, a 3GPP AAA proxy, a WAG, a PDG, a Charging Gateway (CGw)/Charging information Collecting Function (CCF), and an Online Charging System (OCS). The user terminal, WLAN AN, and all the entities of the 3GPP system together constitute a 3GPP -WLAN inter-working network, which can be regarded as a WLAN service system. In this service system, the 3GPP AAA server is in charge of authentication, authorization, and accounting of the user terminal, collecting the charging information sent from the WLAN AN and transferring the information to the charging system. The PDG is in charge of transmission of user data from the WLAN AN to the 3GPP network or other packet data networks. The charging system primarily receives and records the charging information of the user terminal transferred from the network while the OCS instructs the network to transmit online charging information periodically in accordance with the expenses of the online charged users, collects statistics and conducts control.

Under non-roaming circumstances, when a WLAN user terminal desires direct access to the Internet/Intranet, the user terminal can access the Internet/Intranet via a WLAN AN after it accomplishes an authentication step with the AAA server (AS) via the WLAN AN. If the WLAN user terminal desires to access the service of the 3GPP packet switched (PS) realm as well, it may further request the service of Scenario 3 from the 3GPP home network. That is, the WLAN user terminal can initiate a service authorization request for Scenario 3 to the AS of the 3GPP home network, which will conduct service authentication and authorization for that request. If the authentication and authorization succeeds, the AS will send an access accept message to the user terminal and assign a corresponding PDG for the user terminal. When a tunnel is established between the user terminal and the assigned PDG, the user terminal can access the service of the 3GPP PS realm. Meanwhile, the offline charging system and OCS records the charging information based on the user terminal's occupation of the network.

Under roaming circumstances, when a WLAN user terminal desires direct access to the Internet/Intranet, it may submit a request to the 3GPP home network by way of the 3GPP visited network for access to the Internet/Intranet. If the user terminal also wants to request the service of Scenario 3 to access the service of the 3GPP PS realm, the user terminal can initiate via the 3GPP visited network a service authorization process at the 3GPP home network. The authorization is carried out likewise between the user terminal and the AS of the 3GPP home network. After the authorization succeeds, the AS assigns the corresponding home PDG for the user terminal. In this case, the user terminal can access the service of the 3GPP PS realm of the home network after it establishes a tunnel with the assigned PDG via the WAG of the 3GPP visited network.

As shown in FIG. 3, in a 3GPP-WLAN inter-working network, if a WLAN is connected at the same time with a plurality of 3GPP visited networks, that is, a plurality of wireless communication networks (the term 3GPP visited networks as used herein refers to Visited Public Land Mobile Networks (VPLMN)) to which the WLAN AN can route the authentication signal, it can be necessary for a WLAN user terminal to select the desired VPLMN to access after the user terminal accesses the WLAN. For example, in China, a WLAN AN may be connected simultaneously to two operating VPLMNs, China Mobile and China Unicom. In this case, a user of China Unicom, after getting access via the WLAN, has to instruct the WLAN AN to access the operating VPLMN of China Unicom.

As another example, a French user may roam to a WLAN in China. If the home network of the French user has roaming protocols with both China Mobile and China Unicom, when the WLAN is connected to both China Mobile and China Unicom, the French user will need to select a VPLMN to get access after accessing the WLAN. At present, however, there has not yet been a solution for how to notify the WLAN of the information about the user terminal-selected network to be accessed.

### SUMMARY OF THE INVENTION

In view of the above, a method for processing network selection information for a user terminal in a WLAN is provided, such that the user terminal can select an appropriate wireless communication network to provide access when it seeks access via a WLAN connected to a plurality of wireless communication networks.

In the method for processing network selection information for a user terminal in a WLAN, when a WLAN user terminal accesses a wireless communication network via a WLAN AN, the WLAN user terminal sends to the WLAN AN an authentication signal carrying network selection information.

The method can further include the following steps.

a1. Upon receiving the authentication signal sent by the WLAN user terminal, the WLAN AN judges whether the network selection information can be utilized, and, if yes, proceeds to step a2; otherwise, the WLAN AN ends the current procedure or proceeds to an exception handling procedure;

a2. The WLAN AN, based on the network selection information, forwards the authentication signal to the Authentication Authorization Accounting (AAA) functionality in a network currently serving the WLAN user.

The exception handling procedure can include the following steps. A first hop AAA functionality advises the WLAN user terminal of the information about the wireless communication networks to which the WLAN AN can route the authentication signal. The WLAN user terminal, based on the received information, selects a network, sends the network selection information to the WLAN AN again, and then returns to step a1.

The method can further include the following steps in step a2. The WLAN AN judges whether the network selection information contains the information about the visited network, and, if yes, the WLAN AN, based on the information about the visited network, forwards the authentication signal to an AAA proxy in the visited network. Otherwise, the WLAN AN, based on the network selection information, forwards the authentication signal to an AAA server in the home network of the WLAN user.

In the above solution, the network selection information is placed or entered into a user identity field, which includes a username and a realm name. The method can further include the following steps. Upon receiving the authentication signal from the WLAN user terminal, the AAA proxy in the visited network obtains the realm name of the home network by extracting the realm name portion of the user identity field, and then sends, based on the realm name of home network, the authentication signal of the WLAN user terminal to the AAA server in the home network for authentication and authorization. The method can further include the following steps. Upon receiving the authentication signal of the WLAN user terminal, if the AAA proxy in the visited network decides that the user identity field contains the information of the visited network and the information of the visited network is the same as the information of the network where the AAA proxy is located, then the AAA proxy modifies the user identity field such that the field contains only the realm name of the home network, and sends the modified signal to the home network of the WLAN user.

In the above solution, the network selection information is placed or entered into the user identity field, which includes a username portion and a realm name portion. The method can further include the following steps. Upon receiving the signal from the home network of the WLAN user, the visited network serving the WLAN user adds the information of the visited network to the user identity field and then forwards the signal to the WLAN user terminal.

In the above solution, whether the realm name contains the information of the visited network is decided based on the length of the realm name portion in the user identity field.

In the above solution, the network selection information, placed or entered into the realm name portion of the user identity field, is the realm name of the home network of the user, and the user identity field is defined in the format of a network access identifier (NAI). The network selection information, put in the realm name portion of the user identity field, is the combination of the realm name of the home network of the WLAN user, a separator, and the information of the visited network serving the WLAN user, and the user identity field is defined in the format of NAI. The realm name portion of the user identity field is configured with the identifying information expressly indicating that this realm name portion contains the information of the visited network. The identity of the visited network includes both a mobile country code (MCC) and a mobile network code (MNC). The realm name portion of NAI is in the form of the realm name of the home network@realm name of the visited network; or the identity of the visited network@realm name of the home network; or the identity of the visited network.realm name of the home network.

In the above solution, the network selection information is placed or entered into the username portion of the user identity field, and the user identity field is defined in the format of NAI. Alternatively, the information of the visited network in the network selection information is placed or entered into the realm name portion of the user identity field, the original username and the realm name of home network are put in the username portion of the user identity field and are separated by a separator, and this user identity field is defined in the format of NAI.

The above network selection information is placed or entered into an independently configured field. The WLAN user terminal is a WLAN User Equipment (WLAN UE).

In accordance with the method provided by this invention for processing the network selection information for a user terminal in a WLAN, the authentication signal of the user terminal carries the network selection information of the user terminal. In this way, the WLAN AN can determine the wireless communication network to be accessed by the user terminal based on the network selection information of the current user terminal, thereby giving a solution to the transfer and processing of network selection information when a WLAN user terminal selects a wireless communication network.

Other methods and advantages of the present invention will be or become apparent to one of ordinary skill in the art upon examination of the following drawings and detailed description. It is intended that all such additional methods and advantages be included within this description, be within the scope of the present invention, and be protected by the accompanying claims.

### BRIEF DESCRIPTION OF THE DRAWINGS

FIG. 1 is a schematic diagram illustrating the network architecture of an inter-working WLAN and 3GPP system under roaming circumstances;

FIG. 2 is a schematic diagram illustrating the network architecture of an inter-working WLAN and 3GPP system under non-roaming circumstances;

FIG. 3 is a schematic diagram illustrating the network architecture of a WLAN connecting with a plurality of visited networks; and

FIG. 4 is a flowchart illustrating processing the network selection information of a user terminal in accordance with one embodiment of the present invention.

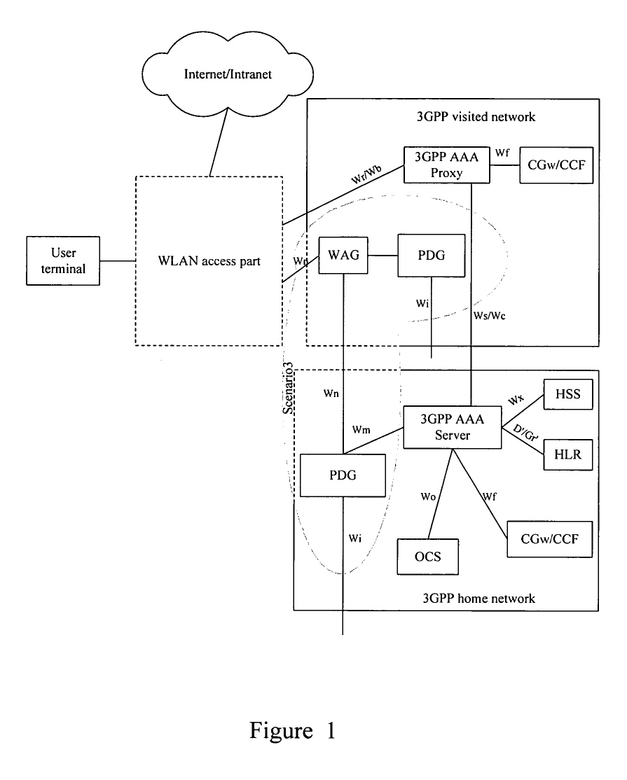

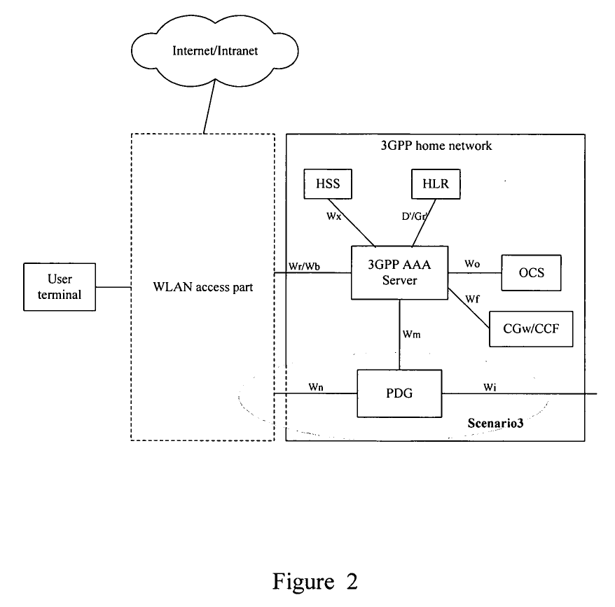

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The present invention can facilitate the transfer of network selection information using an interactive signal between a user terminal and a WLAN. When the user terminal seeks access, the WLAN can recognize a wireless communication network to be accessed by the user terminal and connect the user terminal to the selected network for authentication and subsequent operations.

The network selection information may be placed in an independently configured field in an authentication signal, or placed in a user identity field of the authentication signal. Typically, the user identity field is defined in the format of NAI, and includes a username portion and a realm name portion. The username portion and the realm name portion are separated by the separator @, thus represented as username@realm name. In accordance with one embodiment of the invention, there may be two modes for implementing transmission of the network selection information of a user terminal using the user identity field as the carrier. In one embodiment, the network selection information is placed in the realm name portion. In another embodiment, the network selection information is placed in the username portion. The network selection information may include only the realm name of the home network, or it may include the realm name of the home network plus the information of the visited network, wherein the information of the visited network includes the realm name of the visited network or the identity of the visited network. The identity of the visited network usually includes a standard PLMN identifier, i.e. includes both a MCC and MNC. The identity of the visited network may also include the name of the operator, i.e., such English characters or Chinese characters or characters of other languages as “CMCC”, “ORANGE”, “VODAFONE”, “CHINA MOBILE”, “CHINA UNICOM”, etc. The following description gives as an example the mode in which the information of the visited network is placed or entered in the realm name portion of the user identity field.

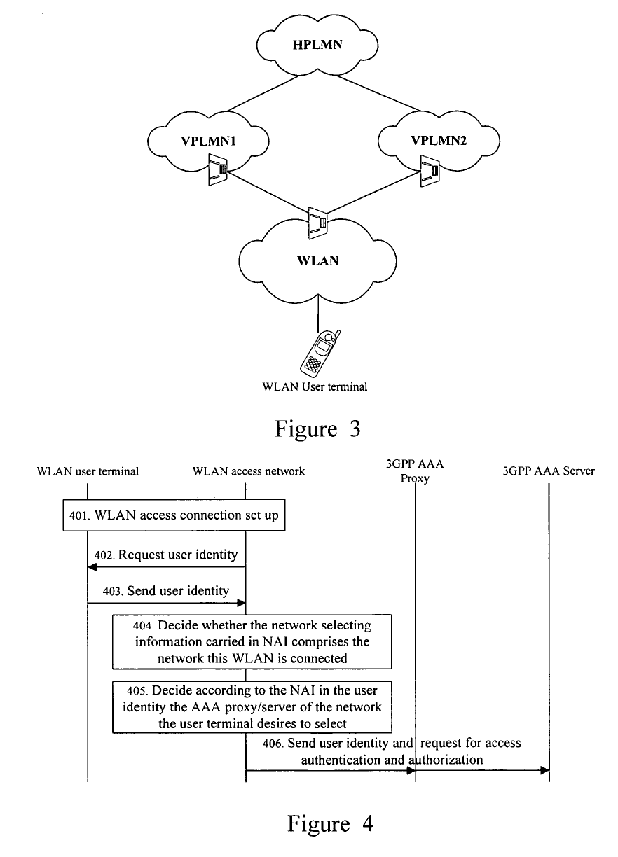

Based on the network architecture shown as FIG. 3, in accordance with one embodiment of the invention, the procedure for transferring and processing the information of a user terminal-selected wireless communication network to be accessed, as shown in FIG. 4, includes the following steps.

Steps 401˜403: When accessing a 3GPP-WLAN inter-working network, a WLAN user terminal connects with the WLAN AN. Then, the WLAN AN sends a user identity request to the user terminal and instructs the user terminal to send an authentication signal carrying the user identity. After receiving the request, the WLAN user terminal sends to the WLAN AN a signal which contains a user identity field, carrying network selection information of the user terminal. The network selection information may be the information of a pre-set wireless communication network to be accessed by the user terminal or the network selected by the user terminal according to the selection information issued by the network.

Step 404: After receiving an access request, the WLAN AN decides whether the network selection information carried in the user identity field is the utilizable information of a wireless communication network connected with this WLAN, and, if yes, performs step 405. Otherwise, if the WLAN can not utilize the network selection information to recognize the wireless communication network, the first hop AAA functionality in the WLAN AN or in a wireless network then issues to the current user terminal the information of the wireless communication networks connected with this WLAN and requests the user identity. The user terminal makes another selection after receiving the message from the WLAN, places the information of the selected wireless communication network in the user identity field NAI, sends the information to the network again for recognition, and returns to step 404. In this step, if the WLAN can not utilize the network selection information to recognize the wireless communication network, the current procedure may be terminated immediately as well, thus not performing the step of issuing the network information to the user terminal and reselecting the network by the user terminal.

Steps 405˜406: The WLAN AN determines the wireless communication network to be accessed by the current user terminal based on the user identity field NAI, i.e., the WLAN AN further judges whether the network selection information carried in the user identity field contains the information of the visited network, and, if yes, the WLAN AN sends an authentication signal to an AAA proxy of the visited network covering the user terminal according to the information of visited network in the user identity field. The AAA proxy then forwards the authentication signal to the 3GPP AAA server of the home network of the user terminal for authentication. Otherwise, the WLAN AN sends the authentication signal to the AAA server of the home network of the user terminal based on the network selection information in the user identity field. In the above two cases, the AAA proxy of the visited network and the AAA server of the home network separately act as the AAA functionality currently serving the user.

After step 406, the procedure may further include the following steps. After receiving the authentication signal of the user terminal, the 3GPP AAA proxy of the visited network judges whether the realm name of the visited network in the user identity field is that of the network where the 3GPP AAA proxy is located. If yes, the 3GPP P AAA proxy removes the information of the visited network in the user identity field and keeps only the realm name of the home network, and then sends the authentication signal to the home network for implementing the authentication and authorization procedure.

In the above procedure, under non-roaming circumstances, the realm name portion of the user identity field is the realm name of home network of the current user terminal, indicating the home PLMN of the user terminal. Then, according to this realm name, the WLAN network sends the AAA signal of the current user terminal to the home PLMN for authentication. Under roaming circumstances, the realm name portion in the user identity field is the roaming realm name, including the realm name of the visited network and the realm name of the home network of the current user terminal. The WLAN network, based on the roaming realm name, sends the authentication information of the current user terminal to the AAA proxy of the visited network. After receiving the user identity field, the AAA proxy of the visited network finds that the realm name portion therein is the roaming realm name and the realm name of the visited network indicates the network where the AAA proxy is located, then extracts the realm name of home network of the user identity field, and sends, based on the realm name of home network, the authentication information of the current user terminal to the AAA server of the home network for authentication and authorization.

There may be several modes of composition of a roaming realm name:

The realm name portion can include the realm name of the home network, a separator, and the realm name of the visited network in order, and the separator may be “@” or “.” or “%” or “!”. Using the separator “@” as an example, the realm name portion of the user identity field can be in the form of the realm name of the home network @ realm name of the visited network, and the user identity field can be in the form of the username @ realm name of home network @ realm name of the visited network. For instance, if the realm name of the visited network is vMCC.vMNC.WLAN.3GPP Network.org and the realm name of the home network is hMCC.hMNC.WLAN.3GPP Network.org, the realm name portion of the user identity field is: hMCC.hMNC.WLAN.3GPP Network.org@ vMCC.vMNC.WLAN.3GPP Network.org.

The realm name portion can also include the identity of the visited network, a separator, and the realm name of the home network in order, and the separator can be “.” or “%” or “!”. Using the separator “.” as an example, the realm name portion of the user identity field can be in the form of the identity of the visited network.realm name of the home network, and the user identity field can be in the form of username@identity of the visited network.realm name of the home network. For instance, if the identity of the visited network is vMCC.vMNC and the realm name of the home network is hMCC.hMNC.WLAN.3GPP Network.org, the realm name portion of the user identity field is: vMCC.vMNC.hMCC.hMNC.WLAN.3GPP Network.org, wherein vMCC is the MCC of the visited network and hMCC is the MCC of the home network.

The realm name portion can also include the identity of the visited network, a separator, and the realm name of the home network in order, and the separator can be “@” or “%” or “!”. Using the separator “@” as an example, the realm name portion of the user identity field can be in the form of the identity of the visited network@realm name of the home network, and the user identity field can be in the form of the username@identity of the visited network@realm name of the home network. For instance, if the identity of the visited network is vMCC.vMNC and the realm name of the home network is hMCC.hMNC.WLAN.3GPP Network.org, the realm name portion of the user identity field is: vMCC.Vmnc@hMCC.hMNC.WLAN.3GPP Network.org, wherein vMCC is the MCC of the visited network and hMCC is the MCC of the home network.

As a way of recognizing a roaming realm name, an explicit identifier may be configured in the realm name of the visited network, indicating that this realm name is a realm name of the visited network, for instance, label the realm name of the visited network as MCC.MNC.WLANvisited.3GPP Network.org, wherein WLANvisited is the explicit identifier; or add an identifying bit before the roaming realm name, for instance, Orealm name of home network@realm name of the visited network indicates that the current realm name is a roaming realm name such that it can be sent to the AAA server capable of handling roaming realm names to be processed. A roaming realm name can also be determined by the length of the realm name, i.e., determine according to the length of the realm name whether the current realm name portion is a roaming realm name, for the length of the variables representing realm names, MCC and MNC, are all fixed.

The implementation of placing or entering the information of the visited network in the username portion is substantially the same as the implementation of placing or entering the information in the realm name portion, and can include the above 3 modes. Alternatively, the realm name of the visited network or the identity of the visited network may be used as the realm name portion of the user identity field while the original username and the realm name of the home network of the user terminal are taken as the username portion of the user identity field, wherein the original username and the realm name of home network are separated by a separator, which may be “@” or “.” or “%”.

In one embodiment of this invention, a roaming realm name is not modified during transmission. The AAA proxy can recognize all the defined roaming realm names and forward the realm names to the home network of the current user terminal. When the home network determines based on the roaming realm name that a user of this network is roaming in another network, the network will process the request of the user terminal in a normal way and interact by modifying the roaming realm name in the identity, i.e., after receiving the signal sent to the current visited network covering the user terminal from the home network of the current user terminal, the AAA proxy of the visited network will replace the realm name portion of the user identity field with the roaming realm name, and then send it to the appropriate user terminal.

As for the signal the network sends to the user terminal, after the visited network covering the current user terminal receives the signal sent by the home network of this user terminal, the visited network will first modify the user identity field in the signal, i.e., add the realm name of visited network or the identity of the visited network in the user identity field, and then send the modified signal to the current user terminal.

After receiving the signal sent down from the network, the WLAN user terminal will also make a decision based on the user identity field in the signal. If the realm name portion of the user identity field of this signal contains only the realm name of the home network, the realm name portion of the user identity field sent by the WLAN user terminal when responding to the network will also take the form of the realm name of the home network only. If the realm name portion of the user identity field in the signal is a roaming realm name, the WLAN user terminal will determine the composition of the realm name portion of the user identity field according to the current network selected by itself when responding to the network. If the network currently selected is the home network, the realm name portion of the user identity field will contain the realm name of the home network only. If the network currently selected is not the home network, the realm name portion of the user identity field includes the realm name of the home network as well as the realm name or the identity of the visited network. When the user terminal selects the wireless communication network to be accessed, even if the signal sent down by the network carries no information about the visited network in the user identity field, the authentication signal sent up by the user terminal will carry the information of the visited network in the user identity field, i.e., in this case, whether or not the user identity field of the signal sent down by the network carries the information of the visited network does not affect the user identity field of the signal sent up. The signal sent down here by the network may be the signal sent by the network issuing the information of the wireless communication network to the user terminal.

The foregoing description is an exemplary embodiment of this invention and should not be construed as limiting the protection scope of this invention. Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A method for processing network selection information for a user terminal in a Wireless Local Area Network (WLAN), when a WLAN user terminal accesses a wireless communication network via a WLAN access network (WLAN AN), comprising sending an authentication signal carrying network selection information from the WLAN user terminal to the WLAN AN.

2. The method according to claim 1, further comprising:
a1. after receiving the authentication signal sent by the WLAN user terminal, determining by the WLAN AN if the network selection information can be utilized, and, if yes, proceeding to step a2; otherwise, ending the procedure or proceeding to an exception handling procedure; and
a2. if the network selection information can be utilized, forwarding from the WLAN AN the authentication signal based on the network selection information to an Authentication Authorization Accounting (AAA) functionality in a network currently serving the WLAN user.

3. The method according to claim 2, wherein the exception handling procedure comprises:
providing information about wireless communication networks to which the WLAN AN is able to route the authentication signal from a first hop AAA functionality to the WLAN user terminal;
selecting a network based on the received information by the WLAN user terminal and sending the selected network information from the WLAN user terminal to the WLAN AN; and
returning to step a1.

4. The method according to claim 3, wherein the first hop AAA functionality is located in the WLAN AN or in a wireless communication network.

5. The method according to claim 2, wherein step a2 further comprises determining by the WLAN AN whether the network selection information contains information from a visited network, and, if yes, based on the information of the visited network, forwarding the authentication signal from the WLAN AN to an AAA proxy in the visited network; otherwise, based on the network selection information, forwarding the authentication signal from the WLAN AN to an AAA server in a home network of the WLAN user.

6. The method according to claim 5, wherein the network selection information is placed in a user identity field comprising a username portion and a realm name portion and wherein the method further comprises, after receiving the authentication signal from the WLAN user terminal, obtaining by the AAA proxy in the visited network the realm name of the home network by extracting the realm name portion of the user identity field and sending by the AAA proxy, based on the realm name of the home network, the authentication signal of the WLAN user terminal to the AAA server in the home network for authentication and authorization.

7. The method according to claim 6, further comprising modifying the user identity field if, after having received the authentication signal of the WLAN user terminal, the AAA proxy in the visited network decides that the user identity field contains the information of the visited network and the information of the visited network is the same as the information of the network where the AAA proxy is located, such that the field contains only the realm name portion of home network, and sending the modified signal to the home network of the WLAN user.

8. The method according to claim 2, wherein the network selection information is placed in a user identity field comprising a username portion and a realm name portion, and wherein the method further comprises, after having received the signal from the home network of the WLAN user, adding by the visited network serving the WLAN user the information of the visited network to the user identity field and forwarding the signal to the WLAN user terminal.

9. The method according to claim 5, further comprising deciding whether the realm name contains the information of the visited network based on the length of the realm name portion in the user identity field.

10. The method according to claim 7, further comprising deciding whether the realm name contains the information of the visited network based on the length of the realm name portion in the user identity field.

11. The method according to claim 6, wherein the network selection information, placed in the realm name portion of the user identity field, is the realm name of the home network of the user, or the combination of the realm name of the home network of the WLAN user, a separator, and the information of the visited network serving the WLAN user, and the user identity field is defined in the format of network access identifier (NAI).

12. The method according to claim 8, wherein the network selection information, placed in the realm name portion of the user identity field, is the realm name of the home network of the user, or the combination of the realm name of the home network of the WLAN user, a separator, and the information of the visited network serving the WLAN user, and the user identity field is defined in the format of NAI.

13. The method according to claim 11, further comprising configuring the realm name portion of the user identity field with identifying information indicating that the realm name portion contains the information of the visited network.

14. The method according to claim 12, further comprising configuring the realm name portion of the user identity field with identifying information indicating that the realm name portion contains the information of the visited network.

15. The method according to claim 13, wherein the information of the visited network comprises the realm name of the visited network or the identity of the visited network.

16. The method according to claim 15, wherein the realm name portion of NAI is in the form of the realm name of the home network@realm name of the visited network, or in the form of the identity of the visited network@realm name of the home network, or in the form of the identity of the visited network.realm name of the home network.

17. The method according to claim 14, wherein the information of the visited network comprises the realm name of the visited network or the identity of the visited network.

18. The method according to claim 17, wherein the realm name portion of NAI is in the form of the realm name of the home network@realm name of the visited network, or in the form of the identity of the visited network@realm name of the home network, or in the form of the identity of the visited network.realm name of the home network.

19. The method according to claim 6, comprising:
placing the network selection information in the username portion of the user identity field and defining the user identity field in the format of NAI;
placing the information of the visited network in the network selection information in the realm name portion of the user identity field;
placing the original username and the realm name of the home network in the username portion of the user identity field;
separating the original username and the realm name by a separator; and
defining the user identity field in the format of NAI.

20. The method according to claim 8, comprising:
placing the network selection information in the username portion of the user identity field and defining the user identity field in the format of NAI;
placing the information of the visited network in the network selection information in the realm name portion of the user identity field;
placing the original username and the realm name of the home network in the username portion of the user identity field;
separating the original username and the realm name of the home network by a separator; and
defining the user identity field in the format of NAI.

21. The method according to claim 1, comprising placing the network selection information in an independently configured field.

22. The method according to claim 2, wherein the network selection information which can be utilized comprises the network selection information which can be used by the WLAN AN to route the authentication signal.

23. The method according to claim 15, wherein the identity of the visited network comprises a mobile country code (MCC) and a mobile network code (MNC).

24. The method according to claim 17, wherein the identity of the visited network comprises a mobile country code (MCC) and a mobile network code (MNC).
